(19) United States
(12) Patent Application Publication
(10) Pub. No.: US 2011/0030978 A1
(43) Pub. Date: Feb. 10, 2011

(54) DEPTH CONTROL SYSTEM

(75) Inventor: John BAKER, Petrolia (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: Penta TMR Inc., Petrolia (CA)

(21) Appl. No.: 12/852,187

(22) Filed: Aug. 6, 2010

Related U.S. Application Data
(60) Provisional application No. 61/231,744, filed on Aug. 6, 2009.

(51) Int. Cl. A01B 63/14

(52) U.S. Cl. 172/239

(57) ABSTRACT

A depth control system for a frame mounted to a movement system, wherein the frame is mounted such that the frame can be raised and lowered in relation to the movement system by a depth adjustment system, the depth control system comprising: a depth control support attached to the depth adjustment system and configured to move with the frame during depth adjustment; a depth control arm extending from the depth control support towards a first end of the frame; a frame guide incorporated to the first end of the frame designed to receive the depth control arm; and a locking mechanism adapted to receive and lock the depth control arm in relation to the frame guide such that the depth control support prevents the frame from moving in at least one direction.

This application claims priority from U.S. Provisional Application No. 61/231,744 filed Aug. 6, 2009, which is hereby incorporated by reference.

### FIELD

This application generally relates to a depth or height control system for equipment that includes implements to be raised and lowered. More particularly, the present application relates to an improved depth or height control system for farm equipment.

### BACKGROUND

Large scale farming involves the use of power-driven assemblies of cultivation equipment to allow for cultivating and planting fields faster, more efficiently, and with less expenditure of resources. In many cases, the equipment, such as tillage equipment, includes a frame or platform that is towed behind a powered vehicle, such as a tractor. These equipment frames can be raised or lowered in relation to supports, typically wheels, in order to bring the tools in contact with the ground or crops at an appropriate height. Maintaining an appropriate height can be an important factor. For example, in planting, seed depth impacts when the plants will germinate and subsequently grow. This can determine when a crop matures and can have an impact on yield or the like.

The raising and lowering of the equipment frame can be handled by hydraulic or similar systems provided on the equipment (here, the term “hydraulics” is intended to include both air and oil types). A disadvantage of using hydraulic systems is the tendency to leak fluid. In these systems, the seals required to separate the pressurized hydraulic fluid from the atmosphere can wear and leaks may occur. Further, when the pressure within the hydraulic system is fluctuating due to differing pressures from the farm implements and the like, additional stresses are placed on the mechanical components of the hydraulic systems, which increases the likelihood of breakdown. If there is a leak or breakdown, the hydraulic system will not be able to maintain or change the height of the frame.

Some conventional systems make use of mechanical stops or the like to maintain height if, for example, the hydraulics fail or are overloaded. However, systems making use of a mechanical stop can be difficult to adjust to a preferred height or depth because they need to be adjusted under a load, whether due to the hydraulics or because the farm implements are in a lowered position or the like. In these systems, the hydraulics typically need to be depressurized before the mechanical stop can be set.

As such, there is need for an improved depth control for height adjustment systems.

### SUMMARY

Generally speaking, the embodiments herein relate to a depth or height control for a depth/height adjustment system on a piece of equipment. In particular, the embodiments relate to a depth control system that provides an improved mechanical stop or locking mechanism in relation to a depth setting of a frame of a piece of equipment. The mechanical stop can be adjusted by a predetermined amount, for example, every ½″, to set the frame at the desired working depth. The depth control system is configured such that it can be adjusted from the front of the equipment, with ease under no load or resistance when the equipment is raised or in the transport mode. There is no need to depressurize the hydraulics or the like.

In one aspect there is provided a depth control system for a frame mounted to a movement system, wherein the frame is mounted such that the frame can be raised and lowered in relation to the movement system by a depth adjustment system, the depth control system comprises: a depth control support attached to the depth adjustment system and configured to move with the frame during depth adjustment; a depth control arm extending from the depth control support towards a first end of the frame, a frame guide incorporated to the first end of the frame designed to receive the depth control arm; and a locking mechanism adapted to receive and lock the depth control arm in relation to the frame guide such that the depth control support prevents the frame from moving in at least one direction.

In a particular case, the locking mechanism of the depth control system may have a sleeve designed to abut against the frame guide, the sleeve comprising at least one positioning hole that matches a plurality of positioning holes within the depth control arm.

In this case, the locking mechanism further may further have a pin designed to fit the at least one positioning hole of the sleeve and the plurality of positioning holes in the depth control arm.

In one particular case, the plurality of positioning holes within the depth control arm may be offset every ½ inch.

In another particular case, the depth control system may include a fine adjustment mechanism. The fine adjustment mechanism may have a clevis and a threaded bolt provided to the connection between the depth control support and the depth control arm.

In some cases, the depth the depth adjustment system may have a suspension system.

In some particular cases, the suspension system further may have hydraulics.

In another aspect, there is provided a depth control system for a frame mounted to a wheel frame, wherein the depth control system is mounted between the frame and the wheel frame such that the frame may be lowered in relation to the wheels, the depth control system comprising: a depth control support and a frame support wherein the depth control support and the frame support are configured to move during depth adjustment; a depth control arm extending from the depth control support towards a first end of the frame, the depth control arm comprising a plurality of positioning holes on an end; a support arm extending from the frame support towards the first end of the frame; a frame guide incorporated to the first end of the frame designed to receive the depth control arm and the support arm; a sleeve designed to abut against the frame guide, the sleeve comprising at least one hole that matches the plurality of positioning holes within the depth control arm; and a pin designed to fit the at least one positioning of the sleeve and the plurality of positioning holes in the depth control arm such that the depth control support prevents the frame from moving in at least one direction.

In a particular case, the plurality of positioning holes within the depth control arm may be offset every ½ inch.

In another particular case, the depth control system may include a fine adjustment mechanism. The fine adjustment mechanism may have a clevis and a threaded bolt provided to the connection between the depth control support and the depth control arm.

In a particular case, the depth control system may be operatively connected to a suspension system. The suspension system may have hydraulics.

In still another aspect, there is provided farm equipment comprising: a movement system; a center frame; a depth control system mounted between the center frame and the movement system such that the center frame can be raised or lowered in relation to the movement system by a depth adjustment system, the depth control system comprising: a depth control support attached to the depth adjustment system and configured to move with the frame during depth adjustment; a depth control arm extending from the depth control support towards a first end of the frame; a frame guide incorporated to the first end of the frame designed to receive the depth control arm; and a locking mechanism adapted to receive and lock the depth control arm in relation to the frame guide such that the depth control support prevents the center frame from moving in at least one direction.

In one case, the farm equipment of claim may have at least one side attachment attached to the center frame wherein the at least one side attachment comprises: a side attachment movement system; a side attachment frame and a depth control system mounted between the side attachment frame and the side attachment movement system such that the side attachment frame can be raised or lowered in relation to the side attachment movement system by a depth adjustment system at a different depth than the center frame, the depth control system comprising: a depth control support attached to the depth adjustment system and configured to move with the frame during depth adjustment; a depth control arm extending from the depth control support towards a first end of the frame; a frame guide incorporated to the first end of the frame designed to receive the depth control arm; and a locking mechanism adapted to receive and lock the depth control arm in relation to the frame guide such that the depth control support prevents the side attachment frame from moving in at least one direction.

In some cases the depth control system of the center frame and the depth control system of the at least one side attachment may have a fine adjustment mechanism. The fine adjustment mechanism may have a clevis and a threaded bolt provided to the connection between the depth control support and the depth control arm.

### BRIEF DESCRIPTION OF FIGURES

For a better understanding of the embodiments described herein and to show more clearly how they may be carried into effect, reference will now be made, by way of example only, to the accompanying drawings which show example embodiments and in which:

FIG. 1 is a photo showing a piece of farm equipment, in particular, farm equipment for tillage, including an embodiment of the depth control system;

FIG. 2 is a photo showing further detail relating to the depth control system of the farm equipment of FIG. 1;

FIG. 3 is a perspective view of another piece of farm equipment including an embodiment of the depth control system;

FIG. 4A is a perspective view of the farm equipment of FIG. 3 with a height adjustment system in an up position;

FIG. 4B is a side view of the farm equipment of FIG. 4A;

FIG. 5A is a perspective view of the farm equipment of FIG. 3 with a height adjustment system in a down position;

FIG. 5B is a side view of the farm equipment of FIG. 5A;

FIG. 6A shows a simplified view of the farm equipment of FIG. 3 showing details of the height adjustment system in an up position;

FIG. 6B shows a detailed view of the height adjustment system of FIG. 6A;

FIG. 7A shows a simplified view of the farm equipment of FIG. 3 showing details of the height adjustment system in a down position;

FIG. 7B shows a detailed view of the height adjustment system of FIG. 7A;

FIG. 8 is a detailed illustration of a fine adjustment mechanism for the farm equipment of FIG. 3; and

FIG. 9 is a detailed illustration of the suspension of the farm equipment according to one embodiment.

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

### DETAILED DESCRIPTION

In the following description, the embodiments relate to farm equipment used for tillage. It will be understood by one of skill in the art that similar principles may be applied to other equipment in a similar way, and should not be considered limited to farm equipment. The embodiments may be applied to equipment with a frame that is mounted to a movement system where it is desirable for the frame to be raised and lowered in relation to a movement system. Other farm implements that may benefit from this system include cultivator blades, chisel plows, or the like. The farm equipment is typically towed behind a powered vehicle, most often a tractor.

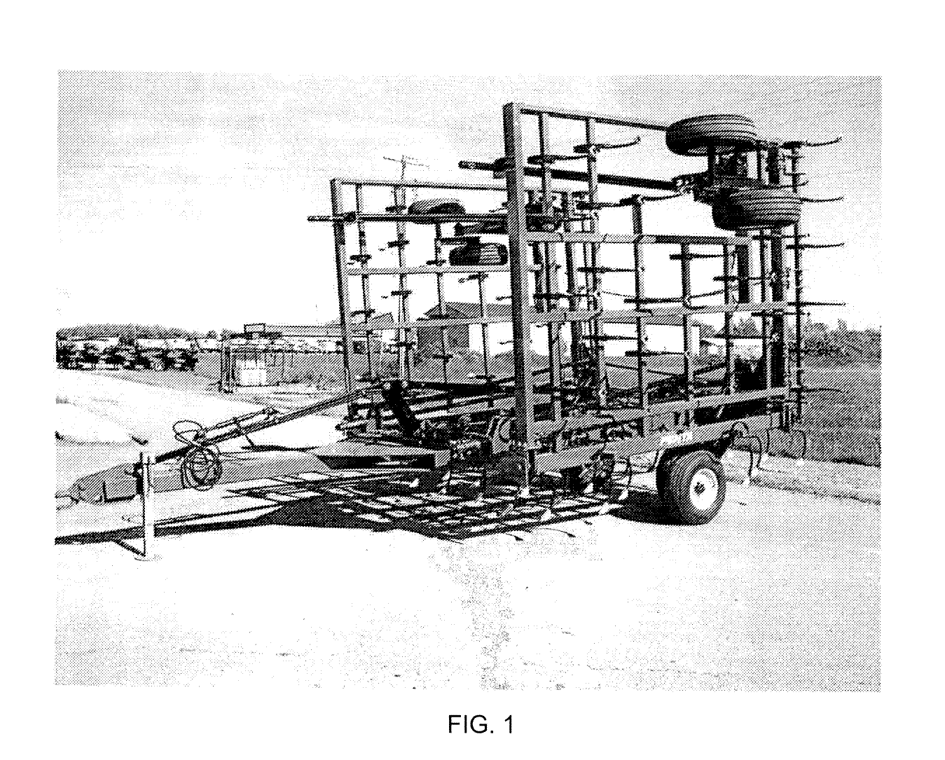

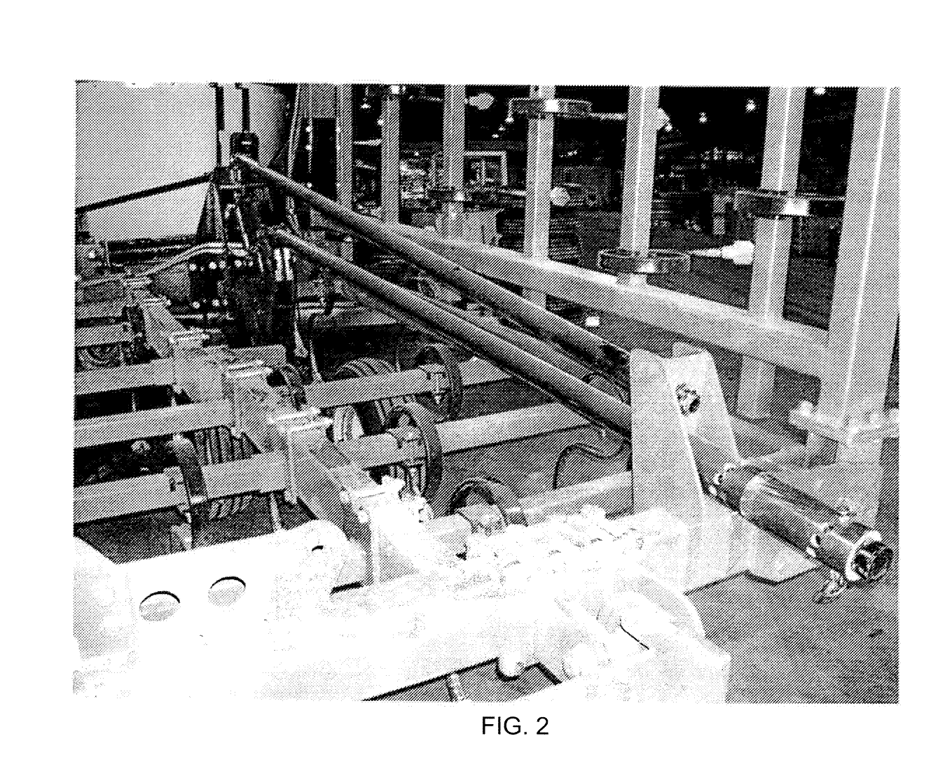

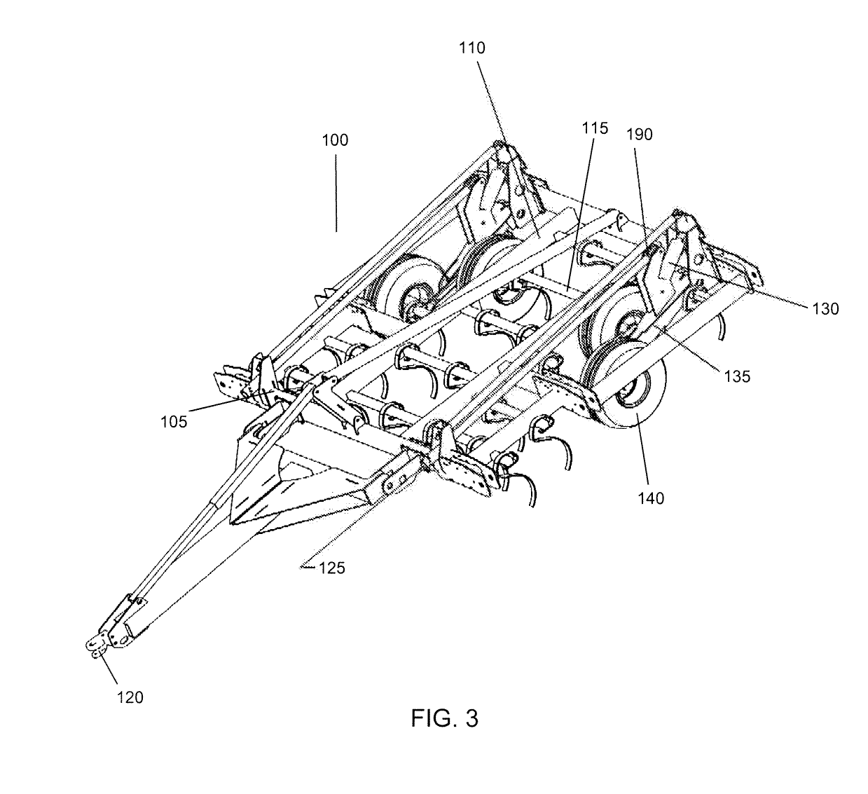

FIGS. 1 and 2 are photographs showing a piece of farm equipment including an improved depth control system. In this case, the farm equipment is configured for tillage. FIG. 3 is a perspective view of another piece of farm equipment 100. The farm equipment typically includes an equipment frame 105 comprising a grid of longitudinal structural members 110 and lateral cross-members 115 that define a roughly rectangular or quadrilateral arrangement. Other equipment may take alternate shapes, for example, a more triangular arrangement, depending on the farm equipment in use. Farm implements, such as cultivator discs and chisel plows, may then be placed on the structural members 110 of the equipment frame 105. A hitch 120 may be provided to allow the farm equipment 100 to be attached to a tractor or other powered vehicle (not shown). Other attachments may be used, such as a drawbar. The farm equipments includes a depth control system 125 and a height adjustment mechanism 130, in this case a hydraulic suspension system, mounted between the equipment frame 105 and a wheel frame 135. Wheels 140 are provided to the wheel frame 135 and provide ground contact points. The wheels 140 are an example of a movement system but the systems herein may also be used with other movement systems, for example continuous track or caterpillar track systems.

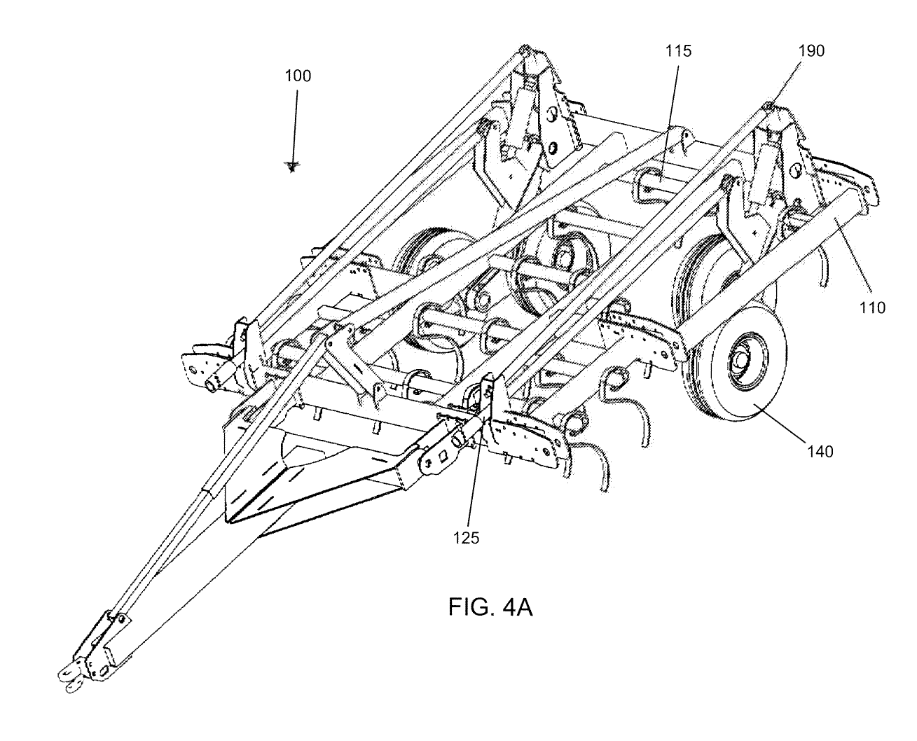

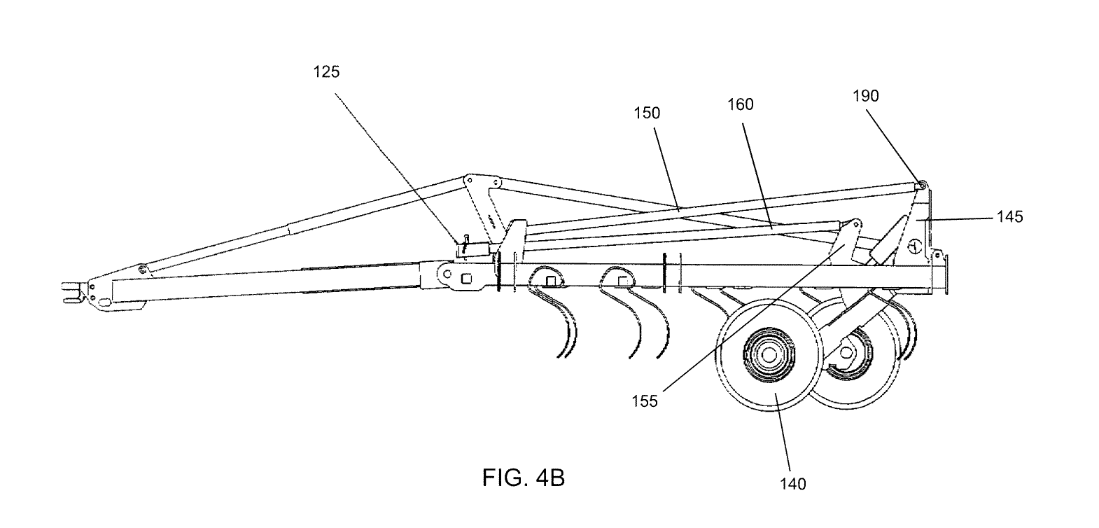

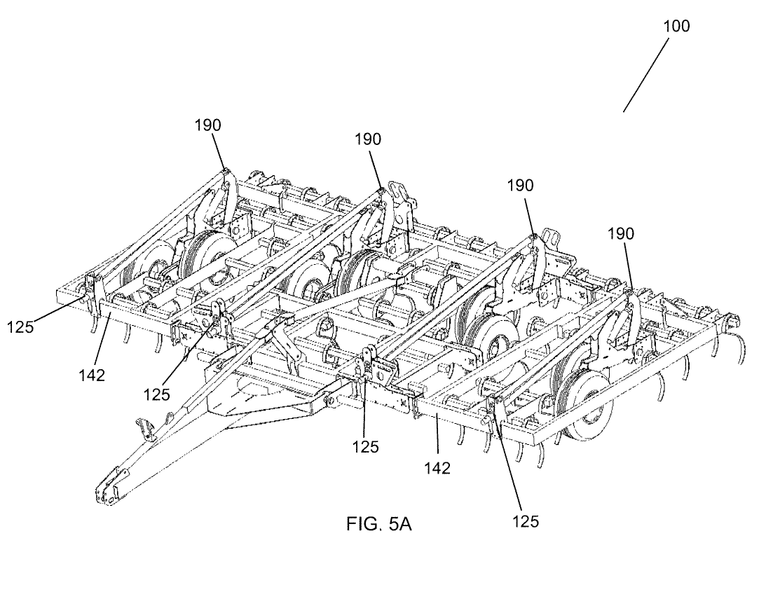

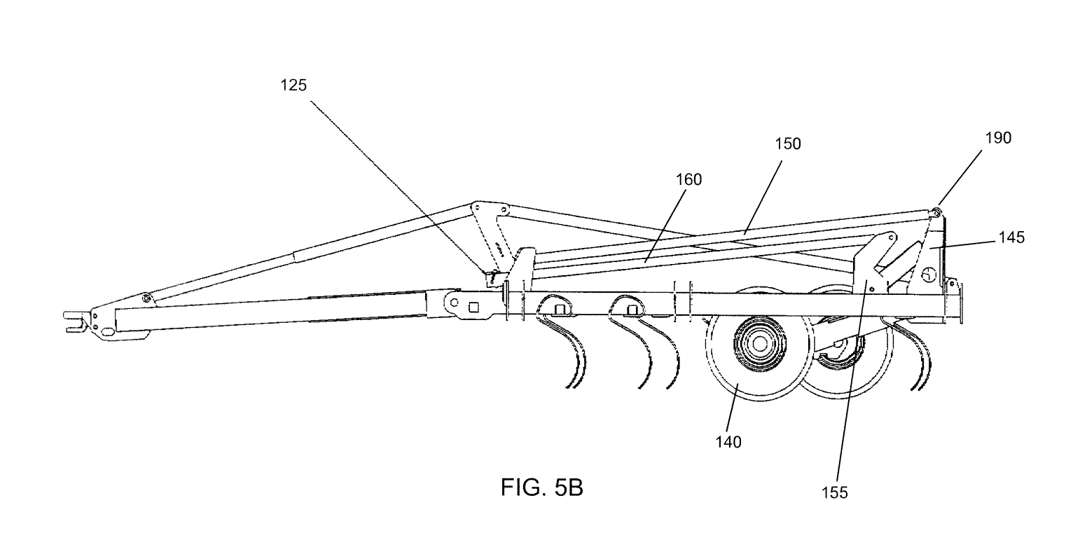

FIGS. 4A, 4B and 5A, 5B show perspective and side views of the farm equipment 100 in up and down positions, respectively. Note that FIG. 5A shows an embodiment in which the equipment includes “wings” as shown in FIG. 1 and described further below. As shown in these figures, the frame 105 can be raised as in FIGS. 4A and 4B and lowered as in FIGS. 5A and 5B with respect to the wheel frame 135 of the equipment 100. As shown in FIG. 5A, the farm equipment may further include “wings”, which are side attachments 142, which may increase the useable area of the farm equipment. The use of side attachments 142, and how they are attached to the farm equipment frame 105 is generally known in the art. The side attachments 142 may also be adapted to include a depth control system 125 and a height adjustment mechanism 130 per each side attachment 142. As each depth control system 125 and height adjustment mechanism 125 may be adjusted independently the side attachments 142 may be at a different depth than each other and than the center frame of the farm equipment 100.

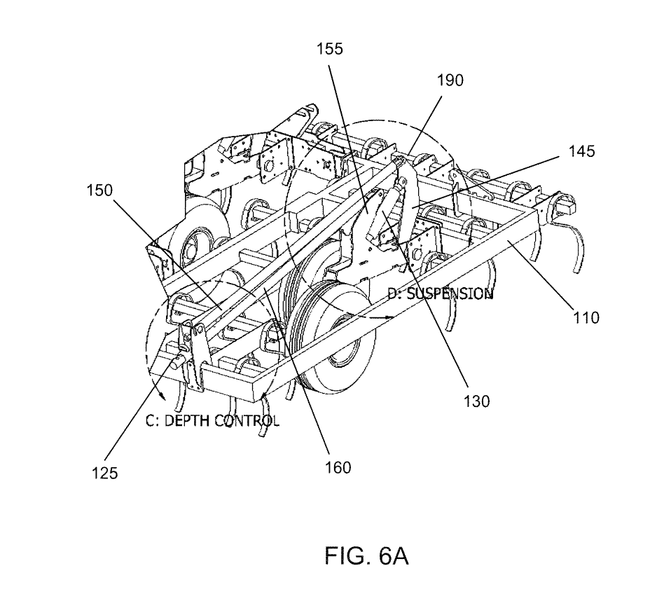

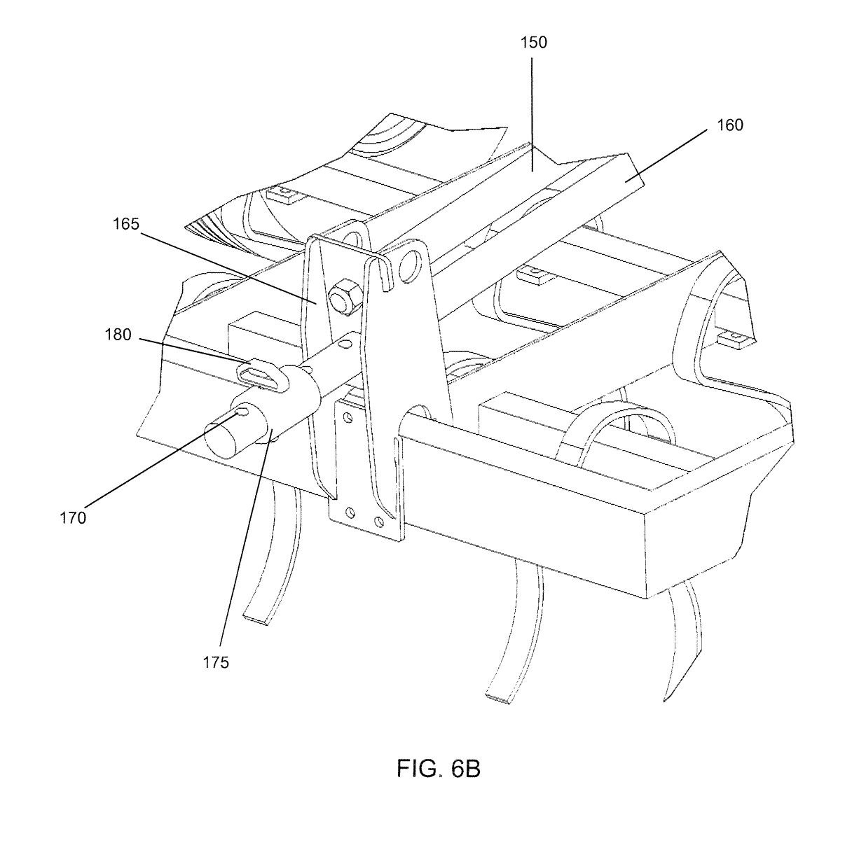

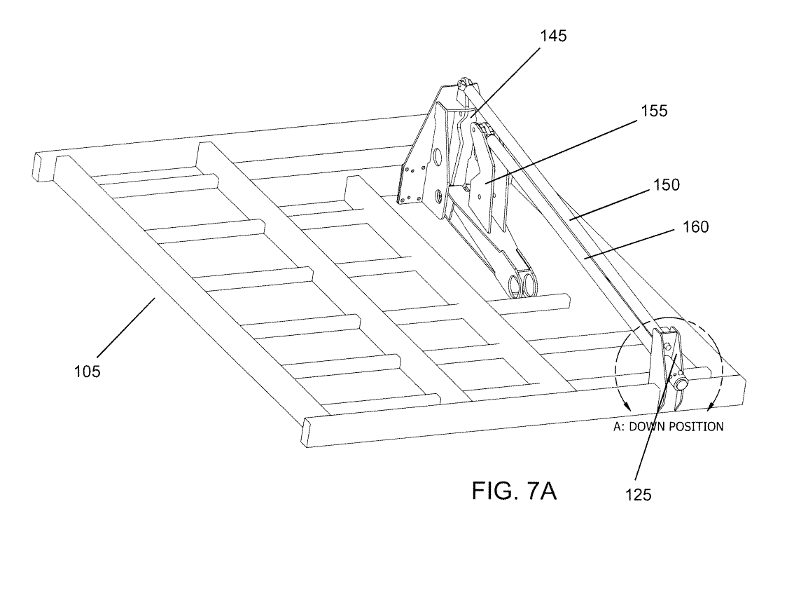

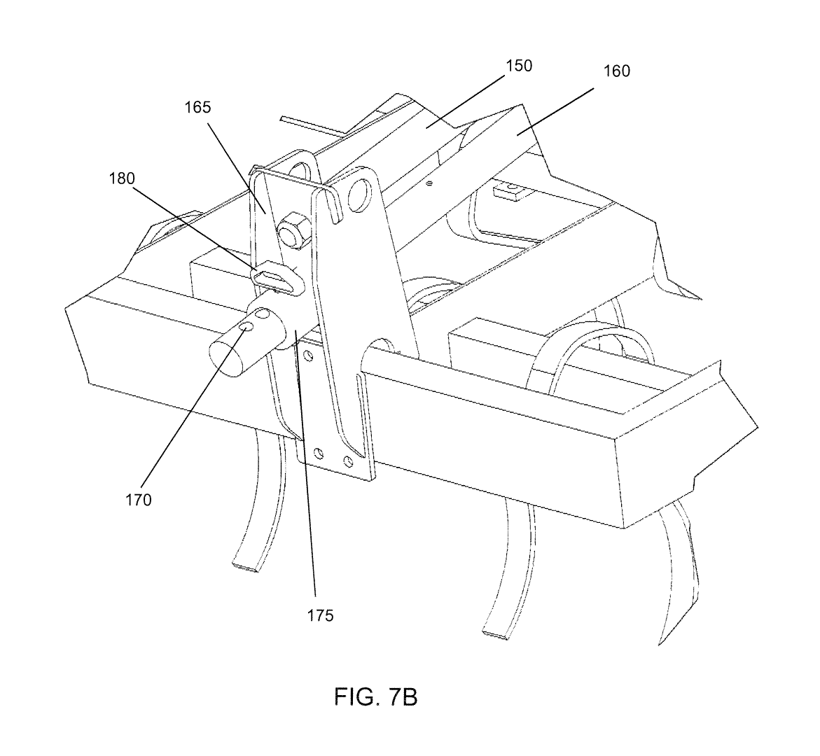

FIGS. 6A and 7A show additional detail of the equipment frame 105 and height adjustment/suspension system 130 in up and down positions, respectively, with FIG. 7A providing a simplified view of the frame 105. The suspension system 130 drives a frame support 145 that is positioned between the equipment frame 105 and the wheel frame 135 to raise or lower the equipment frame 105 in relation to the wheel frame 135 by acting in conjunction with a support arm 150. In this embodiment, a depth control support 155 is provided to the wheel frame 135 and a depth control arm 160 is provided to the depth control support 155. The depth control arm 160 extends from the depth control support to a frame guide 165, which, in this embodiment, is placed at the front of the frame 105. The frame guide 165 may be provided in the frame itself or may be provided as a separate element welded, bolted or otherwise provided to the frame.

The depth control arm 160 extends through the frame guide 165, through an aperture incorporated within the frame guide 165. The depth control arm 160 is provided with a locking mechanism to lock the depth control arm 160 in relation to the frame guide 165 to prevent movement in at least one direction. In this example, the locking mechanism includes one or more positioning holes 170 on at least a portion of the depth control arm 160 that extends through the frame aperture. Another component of the locking mechanism is a sleeve 175 that is provided to fit over the depth control arm 160. The sleeve 175 is larger than the aperture in the frame guide 165 and includes one or more positioning holes that match with the positioning holes 170 on the depth control arm 160 such that the sleeve 175 can be placed at predetermined positions along the depth control arm 160 by use of a pin 180 or the like that passes through the positioning holes 170 of the sleeve 175 and the depth control arm 160. The at least one positioning hole in the sleeve 175 are configured to match the positioning holes 170 in the depth control arm 160 by having a similar diameter, in order for the pin 180 (a component of the locking mechanism) to fit through the positioning holes in both the sleeve 175 and the depth control arm 160. The positioning holes 170 of the depth control arm may be spaced at, for example, approximately ½″ intervals although larger or smaller intervals may be preferred depending on the farm implement being used and the variations of depth required. It will be understood that either of the sleeve 175 or the depth control arm 160 may have a plurality of holes to allow the sleeve 175 to be positioned at the appropriate location for a desired depth setting.

A secondary frame guide (not shown) may be attached to the frame 105 to enclose the sleeve 175 between the frame guide 165 and secondary frame guide. The secondary frame guide would also include an aperture through which the depth control arm 160 may extend. A secondary sleeve (not shown) similar to sleeve 175 could then be used to lock the depth control arm 160 in place in relation to the secondary frame guide to control movement of the depth control arm 160 in a second direction.

FIGS. 6B and 7B show additional detail of the depth control arm 160 and sleeve 175 in up and down positions, respectively. As shown in FIG. 7B, when the equipment frame 105 is lowered, the sleeve 175 will abut the frame guide 165 because it is larger than the aperture in the frame guide 165 and, because of the connection with the depth control arm 160, will not allow the frame 105 to move any lower in relation to the wheels, than the predetermined height set by the sleeve 175. This is intended to be the case even if the hydraulics were to fail. As shown in FIG. 7A, when the frame 105 is raised, the sleeve 175 can be easily moved on the depth control arm 160 to change or set the height/depth without having to depressurize the hydraulic system 130. As such, it is possible to set the depth control system 125 using a locking mechanism, such as a sleeve, in a situation where the depth control system 125 is not under load and the user can easily and efficiently change the setting.

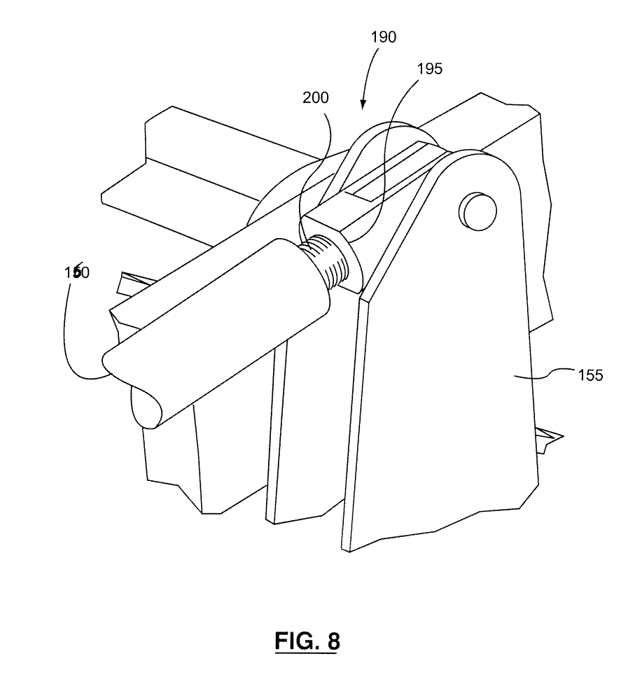

In some cases, there may also be a fine adjustment mechanism 190 that will normally be set before the use of the farm equipment 100. In the embodiment of FIG. 3, the fine adjustment mechanism is at the depth control support 155 where the depth control arm 160 is connected or at the frame support 145 where the support arm 150 is connected. FIG. 8 shows additional detail of this embodiment of the fine adjustment mechanism 190. The fine adjustment mechanism includes a clevis 195 and a threaded bolt 200 provided where the depth control arm 160 connects to the depth control support 155. The depth control arm 160 can be adjusted along the threaded bolt 200 to allow for fine adjustment of the eventual positioning of the sleeve and positioning holes for the depth control system 125.

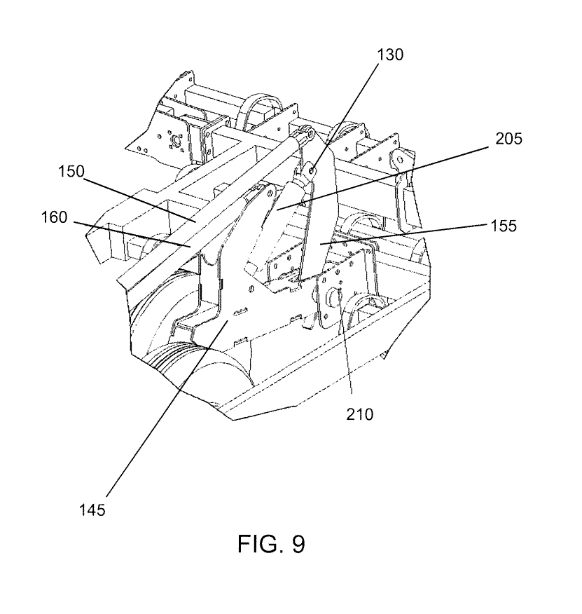

FIG. 9 shows additional detail of the suspension system 130. The suspension system 130 includes a hydraulic cylinder 205 that connects at one end to the depth control support 155 or wheel frame 135 and at the other end to the frame support 145. When the frame 105 is to be raised or lowered, the hydraulic cylinder 205 causes the frame support 145 to pivot around a suspension pivot point 210 connected to the frame 105 and cause the frame 105 to raise or lower in relation to the wheels 140. In this process, the depth control support 145 moves such that, as the frame 105 is raised, the depth control arm 160 slides through the frame guide 165 and the sleeve 175 is adjustable. As the frame 105 is lowered, the depth control arm 160 slides through the frame guide 165 until the sleeve 175 abuts the frame guide 165 and serves to prevent the frame 105 from lowering any further and locks the depth of the frame 105 so that the action of the farm implements cannot pull the frame 105 lower and protects the hydraulic cylinder 205 from excess forces.

In the embodiment of the farm equipment having “wings”, as each of the centre part of the frame and the side attachments may have their own depth control systems 125 and suspension system 130, each suspension system 130 may be operated individually and independently to create different depth levels as required.

It will be understood that other arrangements and embodiments will be apparent to those skilled in the art based on the disclosure of the above embodiments. Further, various modifications can be made to the exemplary embodiments described and illustrated herein, without departing from the general scope of the application.

1. A depth control system for a frame mounted to a movement system, wherein the frame is mounted such that the frame can be raised and lowered in relation to the movement system by a depth adjustment system, the depth control system comprising:
a depth control support connected to the depth adjustment system and configured to move with the frame during depth adjustment;
a depth control arm extending from the depth control support towards an end of the frame,
a frame guide incorporated to the end of the frame designed to receive the depth control arm; and
a locking mechanism adapted to receive and lock the depth control arm in relation to the frame guide such that the depth control support prevents the frame from moving in at least one direction.

2. The depth control system of claim 1 wherein the locking mechanism comprises a sleeve designed to abut against the frame guide, the sleeve comprising at least one positioning hole that matches at least one positioning hole provided to the depth control arm.

3. The depth control system of claim 2 wherein the locking mechanism further comprises a pin designed to fit the at least one positioning hole of the sleeve and the at least one positioning hole in the depth control arm.

4. The depth control system of claim 2 wherein the at least one positioning hole of the depth control arm comprises a plurality of positioning holes that are offset every ½ inch.

5. The depth control system of claim 1, further comprising a fine adjustment mechanism.

6. The depth control system of claim 5 wherein the fine adjustment mechanism comprises a clevis and a threaded bolt provided to the connection between the depth control support and the depth control arm.

7. The depth control system of claim 1, wherein the depth adjustment system comprises a hydraulic system.

8. A depth control system for a frame mounted to a wheel frame via a height adjustment mechanism such that the frame may be lowered in relation to the wheel frame, the depth control system comprising:
a depth control support and a frame support wherein the depth control support and the frame support are configured to move during depth adjustment;
a depth control arm extending from the depth control support towards a first end of the frame, the depth control arm comprising a plurality of positioning holes on an end;
a support arm extending from the frame support towards the first end of the frame;
a frame guide incorporated to the first end of the frame designed to receive the depth control arm and the support arm;
a sleeve designed to abut against the frame guide, the sleeve comprising at least one hole that matches the plurality of positioning holes within the depth control arm; and
a pin designed to fit the at least one positioning of the sleeve and the plurality of positioning holes in the depth control arm such that the depth control support prevents the frame from moving in at least one direction.

9. The depth control system of claim 8 wherein the plurality of positioning holes within the depth control arm are offset every ½ inch.

10. The depth control system of claim 8, further comprising a fine adjustment mechanism.

11. The depth control system of claim 10 wherein the fine adjustment mechanism comprises a clevis and a threaded bolt provided to the connection between the depth control support and the depth control arm.

12. The depth control system of claim 8, wherein the depth control system is operatively connected to the height adjustment system.

13. The depth control system of claim 12, wherein the height adjustment system comprises hydraulics.

14. Farm equipment comprising:
a movement system;
a center frame;
a depth adjustment system mounted between the center frame and the movement system such that the center frame can be raised or lowered in relation to the movement system
a depth control system comprising:
a depth control support attached to the depth adjustment system and configured to move with the frame during depth adjustment;
a depth control arm extending from the depth control support towards a first end of the frame;
a frame guide incorporated to the first end of the frame designed to receive the depth control arm; and
a locking mechanism adapted to receive and lock the depth control arm in relation to the frame guide such that the depth control support prevents the center frame from moving in at least one direction.

15. The farm equipment of claim 14, further comprising at least one side attachment attached to the center frame wherein the at least one side attachment comprises
a side attachment movement system;
a side attachment frame and
a depth adjustment system mounted between the side attachment frame and the side attachment movement system such that the side attachment frame can be raised or lowered in relation to the side attachment movement system at a different depth than the center frame;
a depth control system comprising:
a depth control support attached to the depth adjustment system and configured to move with the frame during depth adjustment;
a depth control arm extending from the depth control support towards a first end of the frame;
a frame guide incorporated to the first end of the frame designed to receive the depth control arm; and
a locking mechanism adapted to receive and lock the depth control arm in relation to the frame guide such that the depth control support prevents the side attachment frame from moving in at least one direction.

16. The farm equipment of claim 15 wherein the depth control system of the center frame and the depth control system of the at least one side attachment further comprise a fine adjustment mechanism.

17. The farm equipment of claim 16 wherein the fine adjustment mechanism comprises a clevis and a threaded bolt provided to the connection between the depth control support and the depth control arm.
